(19) United States
(12) Patent Application Publication
(10) Pub. No.: US 2004/0149130 A1
(43) Pub. Date: Aug. 5, 2004

(54) HEPA filter housing system

(76) Inventor: Dimiter Gorchev, Boston, MA (US)

Correspondence Address: William H. Lee, Lee & Hollander, 287 Hanover Street, Boston, MA, 02113, US

(21) Appl. No.: 10/356,701

(22) Filed: Jan. 31, 2003

(51) Int. Cl. B01D 46/00

(52) U.S. Cl. 95/268; 95/273; 55/309; 55/321; 55/415; 55/418

(57) ABSTRACT

A new system for holding HEPA filters in an air duct. In the present invention, the filters are mounted parallel to the direction of air flow. This allows a filter assembly with essentially unlimited surface area to be installed without increasing the outside dimensions of the duct. This system also allow for easy and convenient replacement of filters.

### FIELD OF THE INVENTION

This invention is related to high volume air moving systems, and more particularly to filtration methods for use in such systems.

### BACKGROUND OF THE INVENTION

An essential part of HVAC air handling systems is filtering the air that passes through to remove pollen, smoke, dust, and other particulate matter suspended in the air. Air filters come in a variety of types which have varying efficiencies.

High Efficiency Particulate Arrestance, commonly called HEPA, filters are frequently used in situations where very high quality air is desired. For example, in clean rooms, semiconductor manufacturing plants, some hospital rooms, and many other types of facilities, HEPA filters are used in the HVAC system to provide air from which essentially all particulates have been removed.

Most HEPA filters require that the air flow rate through the filter be no higher than 100 to 200 feet per minute. Most HVAC systems, on the other hand, have an airflow rate through the ducts and filters of about 400 to 500 feet per minute. Thus, when using a HEPA filter in a typical HVAC installation, some means must be found to reduce the air flow rate through the HEPA filter without making the filter box too large.

This can be accomplished by increasing the area of the HEPA filter relative to the duct area by a factor proportional to the relative air speeds. For example, with a 6×6 foot square duct having an area of 36 square feet and an air flow of 500 ft/sec, to reduce the air flow through a HEPA filter to 200 ft/sec requires a total HEPA filter area of 5/2 the area of the duct, or 90 square feet.

### SUMMARY OF THE INVENTION

The present invention includes a novel arrangement of the HEPA filters which has advantages over previous methods of arranging such filters. In the present invention, the filters are mounted parallel to the direction of air flow. This allows a filter assembly with essentially unlimited surface area to be installed without increasing the outside dimensions of the duct. Using this method also allow for easy and convenient replacement of filters.

### DESCRIPTION OF THE DRAWINGS

The advantages and operation of the present invention are more fully set forth in the following description of the preferred embodiment and by reference to the drawings, of which:

FIG. 1 is a side view of a typical HVAC machinery installation;

FIG. 2 is a perspective view of the installation of FIG. 1;

FIG. 3 illustrates one prior art method of increasing the area of a HEPA filter;

FIGS. 4 and 5 illustrate one prior art method of increasing the area of a HEPA filter;

FIG. 6 shows one embodiment of the invention;

FIG. 7 shows the pattern of air flow through the embodiment of FIG. 6;

FIG. 8 shows a filter holder module incorporating the invention; and

FIG. 9 shows how a plurality of the modules of FIG. 8 may be mounted together.

### DESCRIPTION OF THE INVENTION

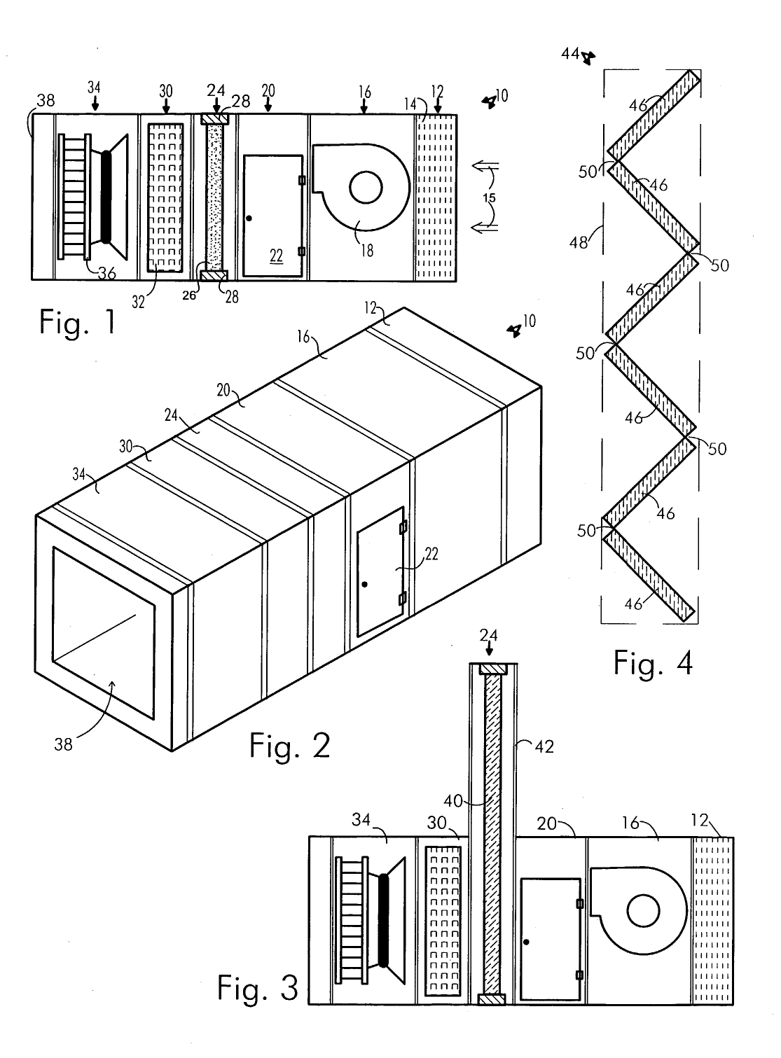

Referring to FIGS. 1 and 2, there is shown the air handling machinery for a typical HVAC system 10. FIG. 1 is a schematic representation shown in side view. FIG. 2 is a perspective view showing installation 10 as it would appear from the outside. It should be appreciated that the particular arrangement shown in FIGS. 1 and 2 are provided for the purpose of explaining the advantages of the present invention and should not be taken as a limitation on the applicability of the invention.

In FIG. 1, the air flow is from right to left. Thus, outside air is pulled in through an intake module 12 by a fan 18 located in fan module 16. Typically, the outside air is drawn through an intake filter element 14, which is a conventional filter for removing larger particulates.

The air next flows through module 20 where recycled air from the building return ducts (not shown)is mixed with outside air. Following module 20 is another filter module 24 which includes another filtering element 26 which is typically a finer filter which filters out smaller particles than the intake filter 14.

One or more access doors, such as door 22 in mixing module 20 may be provided to allow for maintenance. In particular, the filter elements eventually clog up with particulate matter and must be replaced.

In FIG. 1, filter 26 is followed by module 30 which includes cooling and heating coils 32 for controlling temperature and humidity of the air. Finally, air exits the machinery from fan module 34 which is connected to ductwork, not shown, at its end 38. End module 34 includes a circulation fan 36 which recirculates the conditioned air through the installation.

As explained above, each installation will have its own particular design, depending on a host of different requirements, including air flow volume, outside conditions, temperature and air quality requirements, and others. In order to efficiently build and install differing systems, they are typically made up of modules that come in standard sizes, such as 8 feet by 8 feet or 12 feet by 12 feet. FIG. 2 shows how several of these modules can be connected together to provide an airtight duct in which the desired equipment can be deployed.

Typically, the air flow velocity through the mechanical units of an HVAC system is around 400 to 500 ft./min. While most filters will work with these air flow velocities, most HEPA filters will not. While high velocity HEPA filters do exist which can work with a 400-500 ft./min. air flow, these filters are very expensive. The most common types of HEPA filters used in HVAC filtering require air flow velocities in the range of 100-200 ft./min. In order to keep the air flow velocity within the HEPA filter requirements, the surface area of the filter must be increased, as explained above.

One way to increase filter area is simply to increase the size of the filter module to accommodate a larger filter element. This is illustrated in FIG. 3 in which the height of the filter module 24 has been increased by adding an extension 42 so that a larger HEPA filter 40 may be installed in the system. Although shown as a vertical extension in FIG. 3, the filter housing may also be extended horizontally.

Enlarging the filter housing in this way is frequently not satisfactory. The large filter housing 42 must be mated to the ducting on either side with custom hardware. This makes the design more expensive, and more time consuming to fabricate. In many applications, ceiling heights preclude a vertical extension to the filter housing. Horizontal extensions intrude into the surrounding space, if space is available.

Another commonly used method of increasing the surface for HEPA filters is to arrange them in a zig-zag pattern at an angle to the direction of the air flow. This is shown in FIG. 4 where a plurality of HEPA filters 46 are arranged at angles to one another to create a filter assembly 44 that has increased filter surface area compared to the cross-section of the filter assembly 44. FIG. 5 shows an HVAC air handling installation similar to that of FIG. 1 but incorporating a HEPA filter assembly 44 as shown in FIG. 4.

There are disadvantages to HEPA filter assemblies of the type shown in FIG. 4. They require some type of supporting frame, as indicated schematically by dotted line 48, to hold the filter elements in proper alignment. This makes changing and maintaining the individual filter elements more difficult.

Additionally, the joints 50 between the individual filter elements 46 pose problems. A HEPA filter is designed to filter particles down to 0.3 micros in size. Accordingly, the joints 50 must have no openings larger than 0.3 microns. This requires precise alignment of the filter elements by the supporting frame 48 and sealing of the joints with an appropriate material. Because of these factors, it is difficult or impossible to change the individual elements 46 of the filter assembly 44 without adversely affecting the integrity of the filter. Thus, the filter assembly is more expensive to manufacture, and typically the entire assembly must be discarded when the filter is changed.

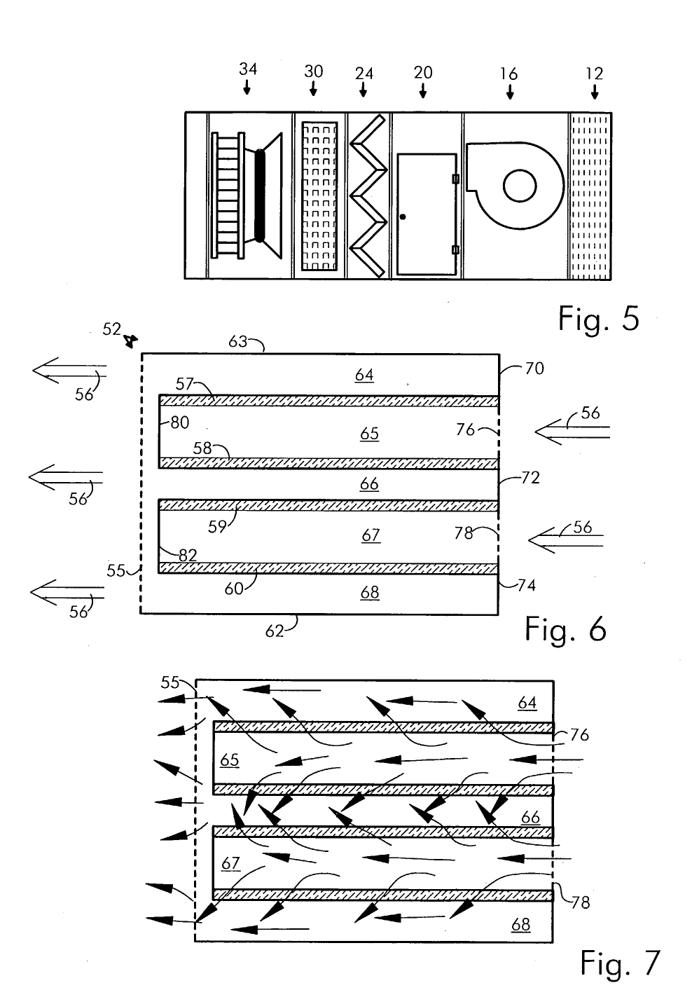

FIG. 6 shows a new configuration for a HEPA filter assembly which is compatible with HVAC machinery installations of the type discussed, although it also has advantages in other applications. FIG. 6 is a top view of the filter assembly which, for example, could be used in place of the filter module 24 in FIG. 5.

In FIG. 6, a square duct section or module 52 has sides 62 and 63. Inside the duct, the filters extend between the top and bottom walls, not shown. The air flow enters from the right and exits to the left, as shown by arrows 56. Inside the module, are four HEPA filters 57, 58, 59, and 60, mounted so that their filter surfaces are parallel to the axis of the duct. The term axis of the duct means a line drawn down the center of the duct.

HEPA filters 57-60 in FIG. 6 are mounted so that the plane of the filter is vertical and they extend from the top to the bottom walls of the module. The result is five separated passages. Passages 65, 66, and 67 are between the filters and passages 64 and 68 are bounded by filters 57 and 60 and side walls 63 and 62 respectively.

On the right hand or intake side of the module, there are a series of baffles preventing air from entering three of the passages. Thus, a baffle 70 between top filter 57 and side wall 63 closes off passage 64 to intake air. Similarly, a baffle 72 between middle two filters 58 and 59, and a baffle 74 between filter 60 and side wall 62 close off the passages 66 and 68 to intake air.

Passage 65 between filters 57 and 58 and passage 67 between filters 59 and 60 are not baffled on the intake side, and intake air can enter at the ends 76 and 78 of these passages. The left side of passages 65 and 67 is blocked by baffles 80 and 82 which go between filters 57 and 58 and between 59 and 60 respectively.

Air can enter passages 65 and 67 through openings 76 and 78 at the intake side of module 52. Since the downstream end of these passages are blocked by baffles 80 and 82, the air must pass through HEPA filters 57-60 and into passages 64, 66, and 68. These passages are baffled on the intake side, and the filtered air flows out the outlet side 55 of the module.

This can more easily be seen by reference to FIG. 7. FIG. 7 shows the same module configuration as in FIG. 6. The arrows represent the air flow into the module and through the HEPA filters. Accordingly, air enters through openings 76 and 78. As the air flows through the passages 65 and 67, it will pass through the filter elements 57-60 into passages 64, 66, and 68 after which it flows out of the filter outlet end 55.

The arrangement of the HEPA filters shown in FIG. 6 has many advantages. As can be seen, the length of the filters 57-60 may be extended to any desired length without increasing the outside dimensions or “form factor” of the ducting which houses the air handling equipment. This allows a designer to implement a wide range of air flow reduction factors through the filters while still maintaining compatibility with standard machinery duct sizes.

Although FIGS. 6 and 7 show the HEPA filters in a vertical alignment, i.e. with the plane of the filter vertically oriented, it should be appreciated that the advantages of the invention may be obtained with other alignments of the HEPA filters. For example, designing the installation so that the plane of the filters is horizontal is an option that may be advantageous in some situations. Angles of the filter between vertical and horizontal also can be used in the invention.

The number of filters can be greater or less than the four filters shown. Additionally, although the air flow is shown entering from the right-hand side in FIGS. 6 and 7, air can enter from either side of the HEPA filters and still take advantage of the advantages of the invention.

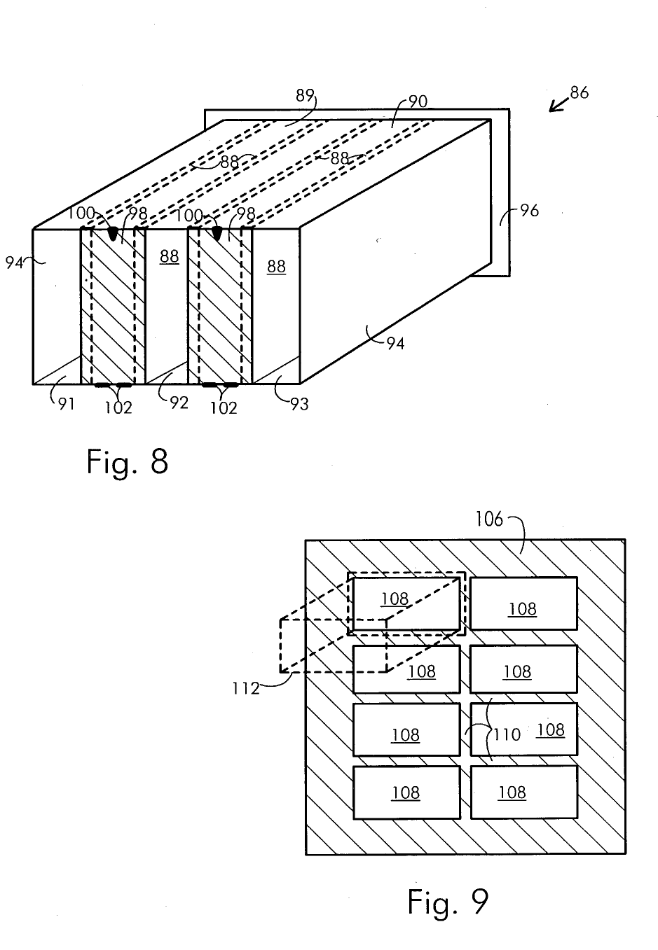

FIG. 8 shows another embodiment of the invention in which the invention is in a modular form. HEPA filters are readily available in many standard sizes, such as 1-foot by 1-foot, 1-foot by 2-foot, and the like. FIG. 8 shows a module which holds four HEPA filters in a configuration similar to that shown in FIG. 6.

Four HEPA filter elements 88 are arranged parallel to one another and are held in place by a frame or chassis 86. These filters might, for example, be 1×2 feet in size. At one end of the chassis is attached a flange 96, or other means for mounting the module to a frame or other support.

The four filters 88 and the sides of chassis 86 form five channels for air flow, denoted as 89-93 in FIG. 8. The two outside channels 91 and 93 and the middle channel 92 have a baffle, not shown in FIG. 8, which blocks air flow at the flange end of the module through these channels. The remaining two channels 89 and 90, have baffles 98 across their opposite side to block air flow into these channels from that end. If the air flow enters at the flange end of the module, the air flow pattern will be similar to that shown in FIG. 7.

The module of FIG. 8 may be deployed in multiple units in order to achieve a high filtering capacity for a large volume air flow. In FIG. 9, a mounting frame 106 is shown, designated by hatching, in which are formed multiple openings 108, each of which can receive a filter module of the type shown in FIG. 8. The individual openings 108 are separated by areas 110 of frame 106 to provide a surface to which modules 86 can be mounted. Frame 106 would be mounted inside a duct or a HVAC module, such as those shown in FIG. 2.

Dotted lines 112 represent a filter module 86 mounted in the upper left hand opening 108 of frame 106. It can be seen that when filter modules are fitted to each opening 108, a large filter surface area is provided in a relatively small space.

Filter maintenance is always of concern because eventually filters clog up and their efficiency decreases. In many filter systems, individual filter elements are not easily removed. For example, a filter module of the type shown in FIG. 4 requires precise alignment of the filter elements and frequently include sealants between the elements. At the least, the entire module must be removed. Frequently, the time and expense of changing the individual elements is prohibitive, and rather than replacing filter elements, the entire assembly is discarded and replaced with a new assembly.

In contrast, the system of FIGS. 8 and 9 can provide extremely fast and easy access to individual filter elements. Referring to FIG. 8, each of the rear baffles 98 is shown with hinges 102 on the lower side and a quick release latch 100 at the top. Other types of fasteners or screws or bolts can also be used in place of latch 100. Thus by opening the baffles, the individual filter elements can be replaced. With a system such as that shown in FIG. 9 having a large number of filter elements in multiple modules 112, replacing individual elements is much faster and less expensive than having to remove and reinstall each of the individual filter modules from the frame 106, as is required by many prior art systems.

It should be clear that the same advantages will obtain if the baffles at the flange end of the assembly shown in FIG. 8 are made to open for filter replacement, which may be more convenient in some applications where access is more easily provided to that side of the filter module. Additionally, the baffles at both ends may be designed to open.

There has been described a new and useful method and apparatus for utilizing filters, and especially HEPA filters in air handling systems. While the operation and advantages of the invention have been described with reference to the exemplary embodiments described above, it should be appreciated that modifications to these embodiments will be made by those of ordinary skill in the art in applying the teachings of the invention to different situations and applications. Accordingly, the present invention should not be limited by the embodiments described above, but rather the scope of the invention should be interpreted in accordance with the following claims.

What is claimed is:

1. Apparatus for filtering a flow of air, comprising:
a duct within which air can flow and having an upstream end and a downstream end;
means for providing a flow of air through the duct from the upstream end to the downstream end;
a filtering module within the duct, comprising:
a plurality of filters, the filters being planar in form and mounted within the duct such that the plane of the filters is substantially parallel to the axis of the duct, so that the filters form a plurality of parallel channels which lie between the filters and between the filters and the walls of the duct;
first baffle means for closing off first selected ones of said parallel channels at the upstream end of the duct;
second baffle means for closing off second selected ones of said parallel channels at the downstream end of the duct, the second selected channels being those parallel channels which are not among the first selected channels, so that air flowing through the duct must pass through the plurality of filters.

2. The apparatus of claim 1 where the plurality of filters are HEPA filters.

3. The apparatus of claim 2 wherein the filters extend all the way across the duct from one side to the other.

4. The apparatus of claim 3 wherein the duct is rectangular in cross-section having top and bottom walls and two side walls.

5. The apparatus of claim 4 wherein at least one of the baffle means includes:
a panel located at one end of each of the the associated first or second channels;
hinge means for allowing the panels to be opened and closed; and
fastening means for holding the panels in a closed position so as to block air flow into or out of the channel.

6. The apparatus of claim 5 further including means for mounting each of the filters so a to allow them to be slidably removed when the baffle means panels are in the open position.

7. In a system having an air flow at a first rate of speed into and out of a duct having a cross-sectional area, a method for providing reduced air flow through a HEPA filter in the duct, comprising the steps of:
providing a plurality of HEPA filter elements in the duct which have a cross-sectional area larger than the cross-sectional area of the duct;
arranging the plurality of HEPA filters parallel to one another and parallel to the general direction of air flow through the duct so as to provide a plurality of channels between the filters and between the filters and the sides of the duct;
blocking the air flow at the downstream end of first alternate ones of the channels;
blocking the air flow at the upstream end of second alternate ones of the channels, where the second alternate ones of the channels include the channels not in the first alternate ones, so that the air flows from the first alternate channels through the filter elements and into the second alternate channels.

8. The method of claim 7 wherein the duct is rectangular in cross section and the filter elements are rectangular in cross section, and
wherein the step of arranging includes the step of locating the plurality of filters parallel to one another and extending across the duct from one wall to the opposite wall to provide said plurality of channels which are rectangular in cross section and parallel to one another.

9. The method of claim 8 wherein the step of blocking the airflow at the downstream end of the duct includes the step of providing a baffle across the downstream end of said first alternate ones of the channels to prevent airflow out of the channel, and
wherein the step of blocking the airflow at the upstream end of the duct includes the step of providing a baffle across the upstream end of said second alternate ones of the channels to prevent airflow into the channel.

10. A filter module for holding HEPA filters to provide filtering in an air handling system, comprising:
a chassis having a rectangular cross section and being open at both ends;
a plurality of HEPA filter mounting brackets, each for receiving and holding in place a HEPA filter so that it can be removed, the filters being positioned so that the filters are parallel to one another and extend along the axis of the chassis so as to form a plurality of channels between the filters and between the filters and the chassis walls;
a first plurality of baffles mounted across the ends of alternate channels so as to block air flow into or out of the associated channel;
a second plurality of baffles mounted across the ends of the channels not blocked by the first baffles and located so as to block air flow into or out of the associated channel; and
means, located at one end of the chassis, for mounting the chassis to an opening through which air can flow.

11. The apparatus of claim 10 wherein at least one of the first and second baffles includes means for allowing the baffle to be opened to allow for removal and replacement of HEPA filters.

12. The apparatus of claim 11 further including a plurality of HEPA filters located in each of said mounting brackets.

13. The apparatus of claim 12 wherein the total area of the plurality of HEPA filters is larger than the cross sectional area of the chassis.

14. A multi-module system for providing HEPA filtering of an air flow through a duct, comprising:
a frame located across the duct and including a plurality of module openings, each adapted to mate with the mounting means of a filter modules as called for by claim 11; and
a plurality of filter modules as called for by claim 11, equal in number to the number of module openings, and each mounted to a respective one of the openings.

15. The apparatus of claim 14 further including a plurality of HEPA filters located in each of said mounting brackets in each of said filter modules.

16. The apparatus of claim 15 wherein the total area of the all of the HEPA filters in all of the filter modules is larger than the cross sectional area of the duct.
